(19) United States
(12) Patent Application Publication
(10) Pub. No.: US 2003/0148734 A1
(43) Pub. Date: Aug. 7, 2003

(54) Methods for broadcasting music and reproducing the broadcasting in digital broadcasting system

(75) Inventor: Jung-a Kim, Seoul (KR)

Correspondence Address: SUGHRUE MION, PLLC, 2100 Pennsylvania Avenue, NW, Washington, DC, 20037-3213, US

(73) Assignee: SAMSUNG ELECTRONICS CO., LTD.

(21) Appl. No.: 10/335,262

(22) Filed: Jan. 2, 2003

(30) Foreign Application Priority Data
Jan. 2, 2002 (KR) 2002-107

(51) Int. Cl. H04B 7/00

(52) U.S. Cl. 455/66; 455/45; 84/645; 370/528

(57) ABSTRACT

Methods for broadcasting a music channel and reproducing the broadcasting in a digital broadcasting system are provided. The method for broadcasting a music channel in which lyrics corresponding to the music data determined by a broadcaster is recorded in the Extended Text Table (ETT) of the Program and System Information Protocol (PSIP), and audio data and ETT are multiplexed and transmitted in a single program stream. When a broadcasting channel is selected by a user, the received broadcasting signals are analyzed at the receiving side. If video data does not exist in the signals, the channel is regarded as a music broadcasting channel and lyrics recorded in the ETT are displayed on a screen while reproducing the audio data.

### BACKGROUND OF THE INVENTION

1. Field of the Invention

The present invention relates to methods for digital broadcasting and reproducing the broadcasting, and more particularly, to the methods of broadcasting a music channel and reproducing the broadcasting in a digital broadcasting system.

The present invention is based on Korean Patent Application No. 2002-107, filed Jan. 2, 2002, which is incorporated herein by reference.

2. Description of the Related Art

Since US DirecTV began using digital satellite broadcasting in 1994, related art digital broadcasting has been enforced or prepared globally. The rival media to digital broadcasting is cable television, which is digitalized in Europe and the USA. Further, all broadcasting media is being digitalized since terrestrial broadcasting emitted its test wave in USA and UK in November 1998.

Korea also opened an era of digital broadcasting with a trial of digital satellite broadcasting in July 1996, and the Korean Broadcasting System (KBS) successfully broadcasted the national first digital terrestrial trial broadcast in May 1999, ranking Korea among the advanced countries in the field of digital broadcasting.

Three characteristics of the related art digital broadcasting are multichannel, high quality, and multi-function. Among those features, multichannel involves various channels for specialized broadcasting using fields provided to the viewers, multi-function involves providing a variety of additional service aside from image and sound, which is the most significant distinguishing characteristic between related art digital broadcasting and analog broadcasting.

Due to the advancement of the multiplex technology in the related art, digital broadcasting can transmit image, sound, and data simultaneously, regardless of the content and size. In addition, since digital broadcasting includes a return channel via modem, interactive service is possible, and a processor and an operation system inside a receiver can make various receiving functions possible.

Due to the advancement of such related art technologies, the related art digital broadcasting provides one step upgraded multimedia service to viewers beyond additional services realized in analogue broadcasting.

In the aforementioned related art digital broadcasting system capable of realizing a variety of service, a broadcasting signal includes program information as well as Program and System Information Protocol (PSIP) information. Program information is TV programs provided by a broadcasting station for being broadcast to viewers, and includes user information such as video information, audio information, and caption data. The program is provided in a Transport Stream (TS) format.

The TS format allows for simultaneous transmission of video, audio and data in a single stream format in the Motion Picture coding Experts Group (MPEG)-2 system. The TS includes one or more programs. The TS header includes program information, program time information, and control information for controlling the overall system, comprising the whole stream. The size of the TS packet is 188 bytes, including a header of 4 bytes and a sync byte of 1 byte.

The Program and System Information Protocol (PSIP) is a group of tables designed to be included in the TS for digital television. The purpose of the PSIP information is to write information of a virtual channel transmitted from a particular TS. The PSIP information hierarchically combines factors for writing a particular service of a digital television, including a modulation method of each channel required for normal reception of each channel broadcasting program, carrier frequency, packet ID information for demultiplexing video and audio information from the packet stream transmitted via a carrier channel, program information (i.e., program title), commencing time, synopsis, whether caption service is provided, program classification, and current time.

Accordingly, when a digital broadcasting channel is selected, the digital broadcasting receiver is tuned with corresponding broadcasting channel, and the PSIP information is separated from a packet stream and stored in the inner memory. Video and audio information is demultiplexed using the stored PSIP information.

The PSIP information includes Base Table (BT) information having a corresponding Packet Identifier (PID) (such as a System Time Table (STT)), Rating Region Table (RRT) information, Master Guide Table (MGT) information, and Virtual Channel Table (VCT) information. The PSIP also includes information having a PID defined in the MGT, such as Event Information Table (EIT) and Extended Text Table (ETT) information. The PID here is an ID that distinguishes between multi Elementary Streams (ES) within the Transport Stream (ST) and is located in the header of the TS.

The STT information provides information on current date and time, the RRT information provides information on grades of multi regions, and the MGT information provides the PSIP information corresponding to a version number, table length, and a table type about all of the PSIP information, excluding STT information that operates independent of other tables. The VCT information writes information about a virtual channel, and includes an ETM location and a service type carrying information about the location of the virtual channel, and detailed information of an event in a major channel number, a minor channel number, a modulation mode, carrier frequency, a program number and PSIP information.

The EIT includes information about broadcasting contents. The EIT includes the title, commencing time, of an event (i.e., TV program), on the virtual channel defined in the PSIP information. One piece of EIT has 3 hour long event information, and is able to transmit the total number of 128 EIT from EIT-0 to EIT-127.

The ETT information is an option table used when writing on a virtual channel and an event in PSIP information in detail.

According to the above related art digital broadcasting system's multi channel feature, a music broadcasting channel excluding video signals is provided. Users listen to music by selecting a music channel from the digital broadcasting receiver. When the digital broadcasting system broadcasts music only, a broadcasting station transmits music broadcasting and the receiver receives the broadcasted audio signals and then outputs those broadcasted audio signals to the user through a speaker. The broadcasting station can broadcast signals including the PSIP information having STT and EIT in which the title of the music selection, reproducing time, and reproducing date are recorded.

The aforementioned related art has various problems and disadvantages. For example, but not by way of limitation, when the music channel is selected, the related art digital broadcasting receiver receives audio information only without video information and therefore, the user can listen to the music only, without a background screen.

In addition, in the related art digital broadcasting system, display commands are input for each STT and ETT to obtain STT and EIT information included in the broadcasting signals. Therefore, it is inconvenient, as a command key needs to be selected each time to view STT and ETT information included in the music channel when the music channel that excludes video signals is broadcast.

### SUMMARY OF THE INVENTION

An object of the invention is to solve at least the above problems and/or disadvantages and to provide at least the advantages described hereinafter.

Accordingly, an object of the present invention is to solve the foregoing problems by providing methods for broadcasting a music channel and reproducing the music broadcasting in a digital broadcasting system enabling automatic display of text information corresponding to music of music channel broadcasting signals excluding video signals.

A method for broadcasting a music channel in a digital broadcasting system comprises the steps of determining music data to broadcast, recording text information corresponding the music data in a ETT, multiplexing the music data and the text information recorded in the ETT and generating broadcasting signals, and transmitting the broadcasting signals.

The information recorded in the ETT includes lyrics corresponding to the music data, and may also include various text information corresponding to the music data, such as names of the singer and the writer, etc. of the transmitted music data.

A method for reproducing music broadcasting in a digital broadcasting system comprises the steps of receiving broadcasting signals according to selected channel, parsing the received broadcasting signals, detecting whether audio and/or video data are included in the parsed broadcasting signals, and displaying information recorded in a ETT on screen when the parced broadcasting signals exist in the audio data only, and if the information recorded in the ETT exists.

The step of displaying information recorded in the ETT displays corresponds to reproduction of the audio data included in the broadcasting signals. For example, the information recorded in the ETT can be auto-scrolled corresponding to the audio information.

According to the above suggested methods for broadcasting a music channel and reproducing the music broadcasting in a digital broadcasting system, a broadcasting station transmitting music broadcasting can send text information such as lyrics with audio information excluding video information, and a viewer can listen to the music while viewing the music information such as lyrics on the screen.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram showing a broadcasting device in a digital broadcasting system;

FIG. 2 is a flowchart showing a method for broadcasting a music channel according to the present invention; and

FIG. 3 is a flowchart showing a method for reproducing music channel broadcasting according to the present invention.

### DETAILED DESCRIPTION OF THE PREFERRED EMBODIMENT

The following detailed description will present methods for broadcasting a music channel and reproducing the broadcasting in a digital broadcasting system according to a preferred embodiment of the invention in reference to the accompanying drawings.

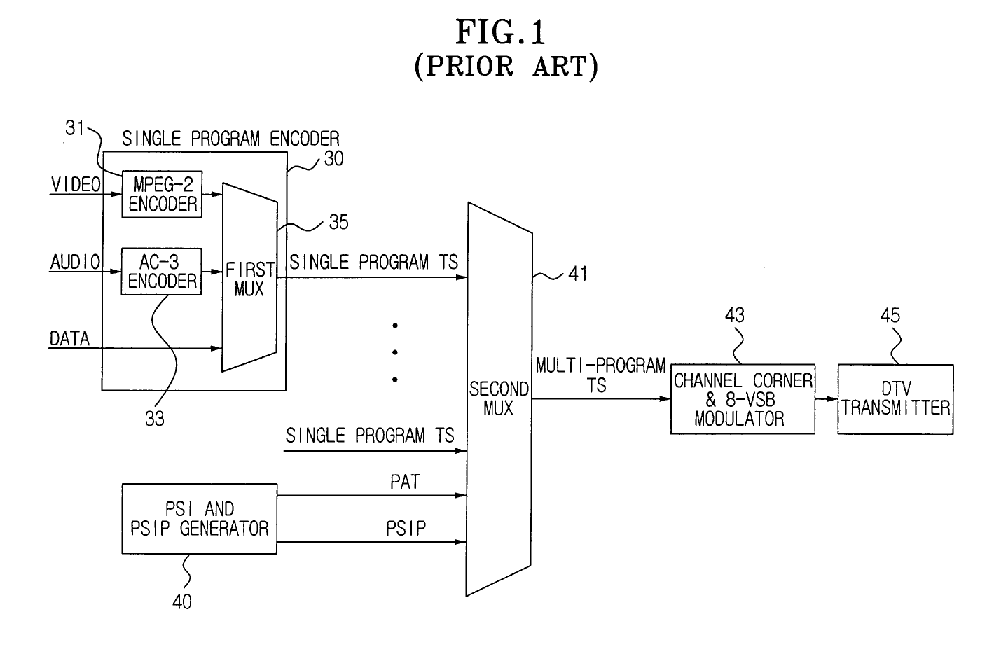

FIG. 1 is a block diagram showing a broadcasting device in a digital broadcasting system. A digital broadcasting transmission device comprises a PSI and PSIP generator 40 capable of producing a Program and System Information Protocol (PSIP) information according to the standard defined by the Advanced Television System Committee (ATSC).

The single program encoder 30 comprises a MPEG-2 encoder 31, an AC-3 encoder 33, and a first multiplexer 35. The MPEG-2 encoder 31 encodes video data, and the AC-3 encoder 33 encodes audio data. The first multiplexer 35 multiplexes the encoded video and audio data and additional information data such as caption into a single program transmission stream. A plurality of single program encoders 30 may be provided, each generating a single program transmission stream.

The PSI and PSIP generator 40 generates PAT and PSIP information. The PAT information informs the PMT PID of each program by a table in which the PID among the PSI information is “0”. The PSIP information includes information about a MPEG-2 transmission stream and Electronic Program Guide (EPG) information. The table defined in the PSIP is created based on the standard of a private table defined in the MPEG-2 system and is multiplexed and transmitted together with image and music data composing a program.

The tables defined in the PSIP include a System Time Table (STT) used for transmitting date and time, a Master Guide Table (MGT) containing versions of the to-be-transmitted tables and a TS packet identifier of to-be-transmitted tables, a Virtual Channel Table (VCT) providing detailed information such as a name of a channel and carrier frequency in the extended standard of the MPEG-2 system program connection table, an Event Information Table (EIT) used for guiding information about the program currently being broadcasted or to be broadcasted in the virtual channel by session, and an Extended Text Table (ETT) for transmitting detailed additional description about the program contained in the EIT.

The second multiplexer 41 receives PAT and PSIP from the single program encoder 30 and the PSI and PSIP generator 40, and multiplexes them into a multi program transmission stream. The modulator 43 receives the multi program transmission stream, and transmits it to the DTV transmitter 45.

If the device illustrated in FIG. 1 is only for music broadcasting, the MPEG-2 encoder 31 for encoding the video data is not required inside the single program encoder 30. In the above digital broadcasting transmitter, the PSI and PSIP generator 40 can record pre-stored lyrics in the ETT and transmit the broadcasting signals after multiplexing them in the second multiplexer 41, together with the corresponding audio data.

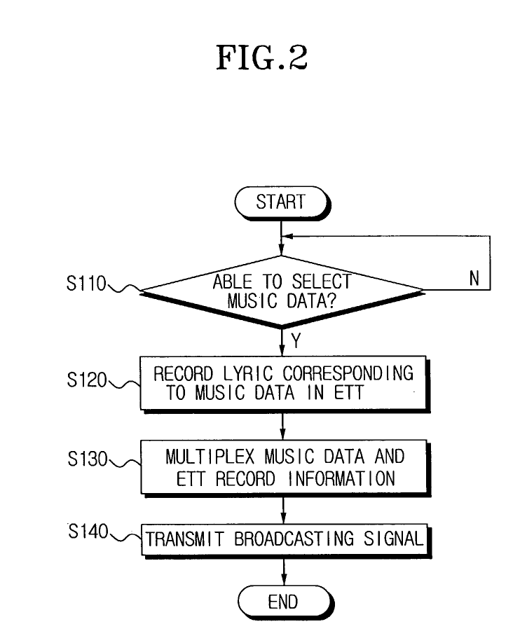

FIG. 2 is a flowchart showing a method for broadcasting a music channel according to the present invention. When the to-be-broadcasted music data, i.e., audio data, is selected (S110), the PSI and PSIP generator 40 records the pre-stored text information corresponding to the music data in the ETT (S120). The second multiplexer 41 then multiplexes the music data encoded in the AC-3 encoder 33 and lyrics recorded in the PSI and PSIP generator 40 in the ETT, and generates a multi program stream (S130). The modulator 43 modulates the multi program stream, and the DTV transmitter 45 outputs broadcasting signals. (S140)

When the broadcasting station propagates music broadcasting through the above method, the DTV reproduces the music data and displays the text information related to the music data on the screen.

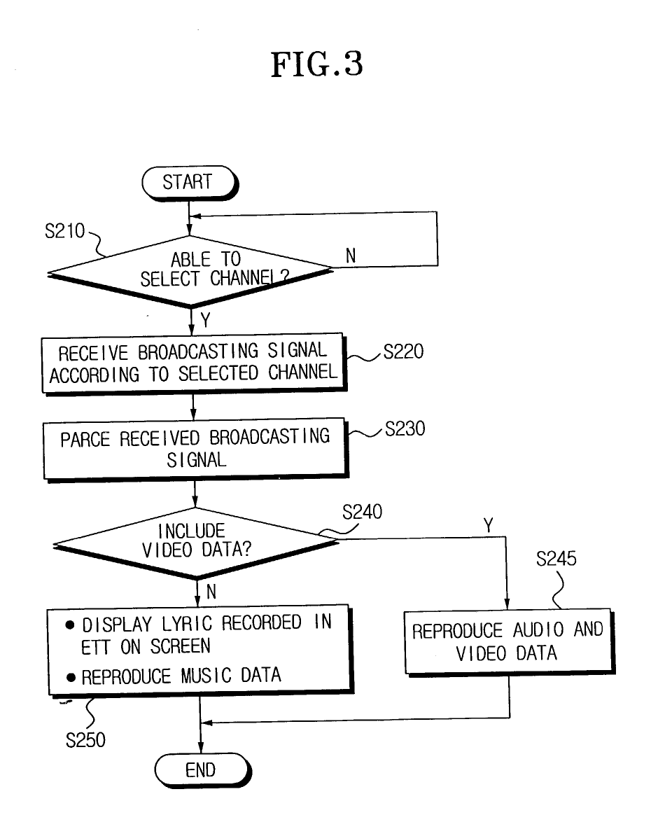

FIG. 3 is a flowchart showing a method for reproducing music channel broadcasting in the DTV according to the present invention. When a channel is selected by a viewer (S210), DTV receives the broadcasting signal according to the selected channel (S220) and parses the received broadcasting signals (S230). The PSIP information is analyzed, and necessary data is stored. During the parsing process, the received broadcasting signals are identified for the inclusion of video data (S240). If video signals are included, the received broadcasting is judged as general digital broadcasting, and the audio and video data included in the broadcasting signals are reproduced (S245).

If only audio signals exist in broadcasting and therefore, the received broadcasting is judged as music specialized broadcasting, the lyrics recorded in the ETT, which are collected during the parsing process, are displayed on the screen and the music data is reproduced (S250). The lyrics displayed on the screen correspond to the music data reproduced. For example, but not by way of limitation, when the displayed lyrics are not shown on a screen, the screen is enabled to be scrolled or skipped according to the reproduced music.

The screen displays not only the information recorded in the ETT, but also the information recorded in the STT and the ETI, which can be automatically displayed together with lyrics without the command of a user, and can also be removed by the user's command. The information recorded in the ETT may include the lyrics as well as the singer and composer of the music being reproduced.

According to the digital broadcasting system of the present invention, a user can listen to the music through the digital broadcasting receiver, and view text information related to the reproduced music shown on the screen without separate operation and other information. Therefore, application of the digital broadcasting receiver can be broadened.

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for broadcasting a music channel in a digital broadcasting system, comprising the steps of:
determining music data to broadcast;
recording text information corresponding the music data in an extended text table (ETT);
multiplexing the music data and the text information recorded in the ETT and generating broadcasting signals; and
transmitting the broadcasting signals.

2. The method for broadcasting a music channel according to claim 1, wherein the text information includes lyrics corresponding to the music data.

3. A method for reproducing music broadcasting in a digital broadcasting system, comprising the steps of:
receiving broadcasting signals according to a selected channel;
parsing the received broadcasting signals;
detecting whether video data is included in the parsed broadcasting signals; and
displaying information recorded in an extended text table (ETT) on a screen when the parsed broadcasting signals exist only in the audio data, and if the recorded information is in the ETT.

4. The method of reproducing music broadcasting according to claim 3, wherein the step of displaying information recorded in the ETT displays information corresponding to reproduction of the audio data included in the broadcasting signals.

5. The method of reproducing music broadcasting according to claim 4, wherein the information recorded in the ETT is auto-scrolled corresponding to the audio information.

6. The method of claim 3, wherein said information comprises singer and/or composer information corresponding to music data.

7. The method of claim 1, wherein said recording is performed by a Program and System Information (PSI) and PSI Protocol (PSIP) generator.

8. The method of claim 1, wherein said text information comprises singer/composer information corresponding to the music data.
